(19) United States
(12) Patent Application Publication
(10) Pub. No.: US 2017/0192648 A1
(43) Pub. Date: Jul. 6, 2017

(54) MERCHANT DASHBOARD SYSTEM

(71) Applicant: PAYPAL, INC., San Jose, CA (US)

(72) Inventors: Sheikh Ashraful Abedin, San Francisco, CA (US); Darwin Lui, Los Altos, CA (US); Emma Catherine Hoare, San Jose, CA (US); Gulshan Ramesh Chand, San Jose, CA (US); David Paul Bozovich, JR., San Jose, CA (US); Damon Bakun, San Jose, CA (US); Jennifer Tran Lee, San Jose, CA (US); Allene Jeanne Yaplee, San Jose, CA (US); Arvind Naidu, Santa Clara, CA (US); Amal John Paul Raj, San Jose, CA (US); Wei Ting Kuo, San Jose, CA (US); Kishore Maley, Fremont, CA (US); Sameera Agrahara Gopalakrishna Rao, Fremont, CA (US); Gautam Satalkar, San Jose, CA (US); Jeremie Michaels Daguman Lim, San Francisco, CA (US); Rúnar Guobjartsson, San Francisco, CA (US); Jiwoong Kim, San Francisco, CA (US)

(21) Appl. No.: 14/985,915

(22) Filed: Dec. 31, 2015

(51) Int. Cl. G06F 3/0484; G06F 3/0482; G06Q 10/06

(52) U.S. Cl. CPC G06F 3/04842; G06Q 10/06393; G06F 3/0482

(57) ABSTRACT

Systems and methods for providing a merchant dashboard system include a system provider device that receives, through communication over a network with a merchant device, a request to create a merchant account and determine one or more merchant attributes, which the system provider device may thereby use to suggest one or more dashboard widgets. The system provider device may then receive a selection of one or more dashboard widgets, and thereby create a customized merchant dashboard based on the received selections. Thereafter, merchant usage data may be collected and additional dashboard widgets may be suggested, providing a mechanism to update the merchant dashboard with timely and relevant widgets that may be of use to the merchant. Thus, the embodiments described herein provide merchants with a customizable, intelligent merchant dashboard system that actively assists the merchant in the completion of a variety of merchant-related tasks.

### BACKGROUND

### Field of the Invention

The present disclosure generally relates to merchant dashboards, and more particularly to a customizable, intelligent merchant dashboard system that actively assists a merchant in the completion of a variety of merchant-related tasks.

### Related Art

More and more consumers are purchasing items and services over electronic networks such as, for example, the Internet. Consumers routinely purchase products and services from merchants and individuals alike. The transactions may take place directly between a conventional or online merchant or retailer and the consumer, and payment is typically made by entering credit card or other financial information. Transactions may also take place with the aid of an online or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online and mobile purchases are growing very quickly.

Moreover, with the explosive growth of electronic commerce (e-commerce) (e.g., buying and/or selling of goods and/or services over an electronic network such as the Internet), merchants find themselves having to digest ever-increasing amounts of data to successfully manage their business. Such data may include, for example, information related to a merchant account (e.g., provided by a payment service provider) such as account balance, transaction activity, or other information related to the merchant account. Additionally, merchants may regularly need to review other information (e.g., provided by one or more third-party applications) such as electronic mail (email), marketing data, inventory data, order data, shipping data, financial data (e.g., revenues, expenses, cash in/out), customer reviews/disputes, as well as other metrics, performance data, and/or other information related to the operation and management of the merchant's business.

Currently, a merchant may have to separately review data provided by the payment service provider (e.g., by way of a payment service provider dashboard accessible via a secure payment service provider application or web page), as well as by each of the one or more third-party applications (e.g., by way of respective, secure third-party applications or web pages), in order to stay up-to-date with information which impacts their business. Thus, a merchant may expend a significant amount of time reviewing and digesting large amounts of information, often from disparate sources, thereby losing time that could be spent focusing on the merchant's actual business.

Thus, there is a need for a merchant dashboard system that is customizable and that actively assists a merchant in the completion of a variety of merchant-related tasks.

### BRIEF DESCRIPTION OF THE FIGURES

FIG. 1 is a schematic view illustrating an embodiment of a merchant dashboard system;

FIG. 2 is a flow chart illustrating an embodiment of a method for providing a customizable, intelligent merchant dashboard system;

FIG. 3 illustrates an embodiment of a merchant device including a screen shot displaying an account creation screen;

FIG. 4 illustrates an embodiment of a merchant device including a screen shot displaying a business information screen;

FIG. 5 illustrates an embodiment of a merchant device including a screen shot displaying a dashboard widget selection screen;

FIG. 6 illustrates an embodiment of a merchant device including a screen shot displaying a merchant dashboard including a plurality of widgets;

FIG. 7 is an illustrative detailed widget view, in accordance with some embodiments;

FIG. 8 illustrates an embodiment of a merchant device including a screen shot displaying a dashboard widget update screen;

FIGS. 9A and 9B illustrate an embodiment of a merchant device including a smart phone and including a screen shots displaying portions of a merchant dashboard;

FIGS. 10A and 10B illustrate an embodiment of a merchant device including a smart watch and including a screen shots displaying portions of a merchant dashboard;

FIG. 11 is a schematic view illustrating an embodiment of a networked system;

FIG. 12 is a perspective view illustrating an embodiment of a merchant device;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing a merchant dashboard system that provides merchants with a customizable dashboard (e.g., providing data visualization) that may be configured on a merchant-by-merchant basis (e.g., by selection of appropriate dashboard widgets) to report information from any of a plurality of data sources to a merchant. Additionally, embodiments described herein may be equally applicable to merchants operating a physical merchant location as well as merchants operating a virtual storefront accessible to a customer via a website (e.g., accessible through an Internet connection using a mobile device and/or a personal computer) or via a mobile application executing on the customer's mobile device.

Generally, dashboards have been used to provide at-a-glance views of key performance indicators, for example, relevant to a particular business objective or business process. Moreover, dashboards have conventionally been limited to show summaries, trends, comparisons, and exceptions. In the example of a payment service provider, dashboards have conventionally been used to show account balances, transaction activity, or other information related to the merchant account. In addition, merchants may regularly need to review information provided by one or more third-party applications such as email, marketing data, inventory data, order data, shipping data, financial data (e.g., revenues, expenses, cash in/out), customer reviews/disputes, as well as other metrics, performance data, and/or other information related to the operation and management of the merchant's business.

More importantly, regardless of the specific information conveyed, existing dashboards are largely non-customizable. This presents a considerable challenge, given the fact that merchants can be vastly different from one another and may thus rely on different types of data and/or information that is relevant to a merchant's particular industry, business type, etc. For example, a merchant's business type may include business-to-business (B2B), business-to-consumer (B2C), consumer-to-business (C2B), or consumer-to-consumer (C2C), a merchant may sell a variety of products and/or services, a merchant may operate a physical merchant location and/or a virtual storefront (e.g., accessible through the Internet, via a mobile application, etc.), and/or a merchant may have a variety of other different attributes.

Thus, in at least some existing examples, a merchant may use a dashboard to review a subset of information relevant to the merchant's business, but the merchant may further have to separately review data provided, for example, by a payment service provider, as well as by each of one or more third-party application, in order to stay up-to-date with information which impacts their business. Thus, merchants may expend a considerable amount of time and energy reviewing and digesting large amounts of information, often from disparate sources, thereby losing time that could be spent focusing on the merchant's actual business.

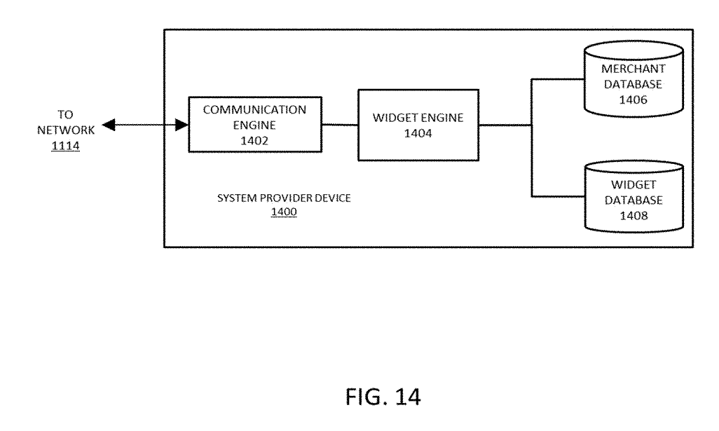

By providing the merchant dashboard system as described herein, a merchant is provided with a smart, fully customizable dashboard that provides the merchant with timely, relevant data, alerts, and/or other actionable or informative information. For example, in accordance with embodiments described herein, dashboard customization may be implemented by selection of, and on-going recommendation of, widgets to provide relevant, timely information from any of a plurality of data sources to a merchant. As used herein, the term “widget” may be used to describe a software application (e.g., software widget), component, applet, portlet, or other such stand-alone applications as known in the art, where individual widgets may be dedicated to conveying a particular type of data or information, as described in more detail below. Additionally, in various embodiments, widgets may include a graphical user interface (GUI) widget, a desktop widget, a mobile widget, or a web widget, among others. As also described below with respect to FIG. 14, the widgets described herein may be configured to run on a “widget engine”.

In various embodiments, a merchant may select a set of widgets upon creation of the merchant dashboard, and widgets may be recommended (e.g., by a payment service provider) based on merchant actions, actions of other similar merchants, or based on other factors, as described below. In addition, embodiments of the present disclosure may include integration of external data from any of a plurality of external third-party data sources (e.g., via the merchant dashboard widgets described herein). In some embodiments, the merchant dashboard system provided herein may also include “active listeners”, where such active listeners may be used to continually refresh data/information displayed via a widget, may provide timely alerts and/or notifications based on event triggers, and generally may be used to push data/information to a merchant (e.g., via the merchant dashboard), thereby acting as an active merchant assistant.

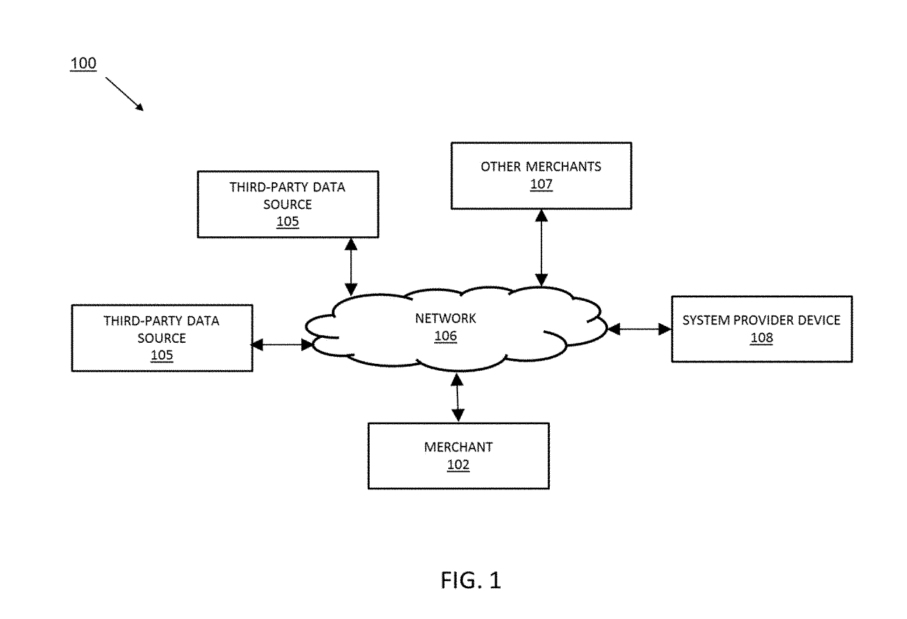

Referring now to FIG. 1, an embodiment of a merchant dashboard system 100 is illustrated. The merchant dashboard system 100 includes a merchant 102. In various embodiments, the merchant 102 may include a merchant operating a physical merchant location and/or a merchant virtual storefront accessible to a customer via a website (e.g., accessible through an Internet connection using a mobile device and/or a personal computer) or via a mobile application executing on the customer's mobile device. While the embodiments herein are generally shown and described with reference to a single merchant (e.g., merchant 102) for the sake of clarity, it will be understood that various embodiments may include a plurality of merchants at a plurality of merchant physical locations, a single merchant having a plurality of merchant physical locations, a plurality of merchants operating a plurality of merchant virtual storefronts, and/or a single merchant operating a plurality of merchant virtual storefronts. In various examples, the merchant 102 includes one or more merchant devices that are coupled to a network 106 that is further coupled to a system provider device 108. For example, the merchant 102 and the system provider device 108 are configured to communicate with one another by way of the network 106, for example by way of network communication devices, as discussed below.

In the embodiments illustrated and discussed below, the merchant 102 may provide a physical location such as a department store, a restaurant, a grocery store, a pharmacy, a movie theater, a theme park, a sports stadium, and/or a variety of other merchant physical locations known in the art. Moreover, in some embodiments, the merchant 102 physical location may include a mobile merchant location such as a cart, kiosk, trailer, and/or other mobile merchant location as known in the art. In addition, in various embodiments, the merchant 102 may include a virtual storefront that serves to complement the merchant physical location. In still other embodiments, the merchant 102 may not include a merchant physical location, and may instead only include a merchant virtual storefront, as described above.

The network 106 may be implemented as a single network or a combination of multiple networks. For example, in various embodiments, the network 106 may include the Internet and/or one or more intranets, landline networks, wireless networks, cellular networks, satellite networks, and/or other appropriate types of networks. In some examples, the merchant 102 may communicate through the network 106 via cellular communication, by way of one or more merchant network communication devices. In other examples, the merchant 102 may communicate through the network 106 via wireless communication (e.g., via a WiFi network), by way of one or more merchant network communication devices. In yet other examples, the merchant 102 may communicate through the network 106 via any of a plurality of other radio and/or telecommunications protocols, by way of one or more merchant network communication devices. In still other embodiments, the merchant 102 may communication through the network 106 using a Short Message Service (SMS)-based text message, by way of one or more merchant network communication devices.

The system provider device 108 may likewise couple to the network 106 via a wired or wireless connection. As described in more detail below with reference to FIG. 14, the system provider device 108 may include a widget engine, a communication engine, a widget database, and a merchant database. Software or instructions stored on a computer-readable medium, and executed by one or more processors of the system provider device 108, allows the system provider device 108 to send and receive information over the network 106. Furthermore, the widget engine in the system provider device 108 may be configured to implement the various embodiments of the merchant dashboard system as described herein. In some examples, the system provider device 108 is configured to receive a request (e.g., from a merchant) to create a merchant account. In some embodiments, as part of the creation of the merchant account and based on determination of one or more merchant attributes such as merchant business type, industry, and/or other merchant attributes, as described above, the system provider device 108 may suggest an initial set of widgets to populate a merchant dashboard. In some examples, the merchant may select one or more widgets from the suggestions provided by the system provider device 108. Alternatively, or in conjunction with selection of widgets suggested by the system provider device 108, a merchant may manually select one or more widgets to populate the merchant dashboard. As the merchant 102 uses the merchant dashboard system 100, the system provider device 108 may collect merchant usage data and provide additional and/or alternative widget suggestions based on the collected merchant usage data. Also, in some embodiments, the system provider device 108 may collect merchant usage data from other merchants 107, where the other merchants 107 may have the same or similar business type as the merchant 102, where the other merchants 107 may be in the same or similar industry as the merchant 102, and/or where the other merchants 107 may have other attributes that are similar to the merchant 102. Based on the collected merchant usage data from the other merchants 107, which may include information related to widgets used by the other merchants 107, the system provider device 108 may provide additional and/or alternative widget suggestions to the merchant 102.

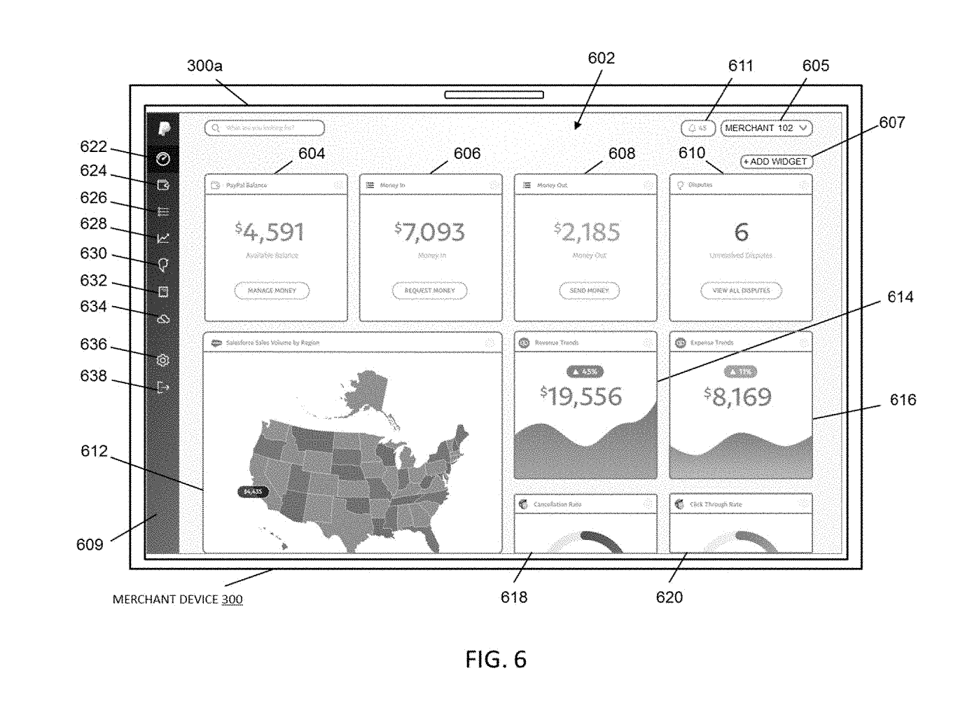

As illustrated in FIG. 1, one or more third-party data sources 105 may likewise couple to the network 106 via a wired or wireless connection. In various examples, the third-party data sources 105 may include, but are not limited to, email service providers, payment service providers, marketing service providers, accounting service providers, shipping service providers, social networking service providers, e-commerce service providers, and/or other third-party service providers as known in the art. As such, the third-party data sources 105 may communicate data (e.g., email, marketing data, inventory data, order data, shipping data, financial data such as revenues, expenses, and/or cash flow, customer reviews/disputes) to the system provider device 108. In some cases, such transmitted data includes raw, unformatted data, which the system provider device 108 may format and visualize to provide the merchant dashboard (e.g., as illustrated in FIG. 6) to the merchant 102. Thus, regardless of the third-party data source, the system provider device 108 is configured to provide a uniform presentation of the merchant dashboard to the merchant 102. In some embodiments, the system provider device 108 may further provide the active listeners, as discussed above, for the merchant dashboard system 100.

For merchants having a merchant physical location, the arrival, departure, and/or position of the one or more customers (e.g., via customer devices) to the merchant physical location may be detected by way of one or more beacon devices (e.g., in communication with a customer device) in a beacon system implemented at the merchant physical location. As such, in some embodiments, the merchant dashboard system 100 may also provide such customer traffic and location information to the merchant 102, for example, via an appropriate widget. In addition, in some embodiments, the system provider may include a payment service provider such as, for example, PayPal Inc. of San Jose, Calif., that provides the merchant dashboard system 100 for the merchant 102, as well as any other merchants implementing the merchant dashboard system 100.

Information sent and received through the network 106, merchant devices, and customer devices may be associated with merchant 102 accounts in a database located in a non-transitory memory, and any use of that information may be stored in association with such merchant 102 accounts. Furthermore, the payment service provider may provide the merchant dashboard system 100 for a plurality of different merchants, similarly as described for the merchant 102, discussed below. Thus, references to a system provider operating a system provider device below may refer to a payment service provider operating a payment service provider device, or may refer to any other entity providing a merchant dashboard system separate from or in cooperation with a payment service provider.

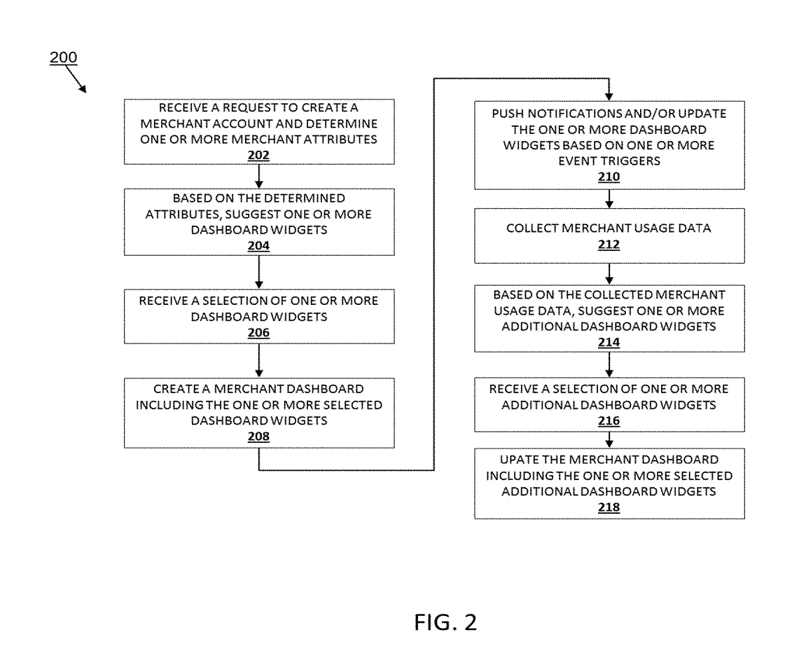

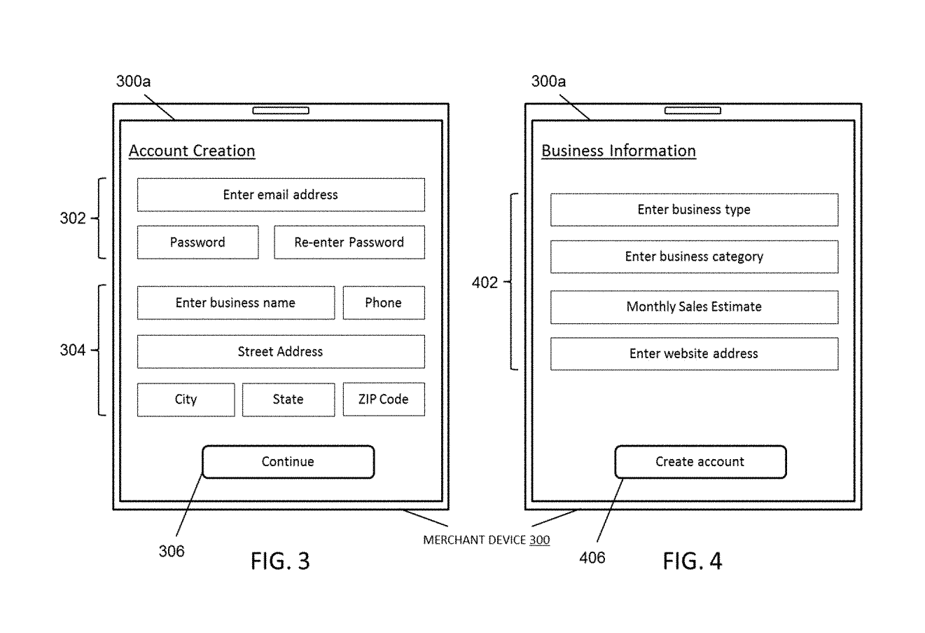

Referring now to FIG. 2, an embodiment of a method 200 for providing a customizable, intelligent merchant dashboard system is illustrated. One of skill in the art in possession of the present disclosure will recognize that the method 200 may be performed for a plurality of different merchants at a variety of physical locations and/or a plurality of different merchants operating a plurality of merchant virtual storefronts. It will also be understood that additional steps may be performed before, during, and/or after the steps described below with reference to the method 200. In particular, with reference to FIGS. 3-8, various aspects of the method 200 are illustrated and described.

The method 200 begins at block 202 where a request to create a merchant account is received and one or more merchant attributes are determined. Referring first to FIG. 3, a merchant device 300 is illustrated that includes a display 300a and which may include a touchscreen user interface. The merchant device 300, in accordance with various embodiments of the present disclosure, may include a laptop computer, a desktop computer, a mobile phone, a tablet, and/or any of a variety of other type of computing device as known in the art. In various embodiments, a merchant associated with the merchant device 300 may launch a system provider application and/or a payment service provider application (e.g., a payment application provided by PayPal, Inc. of San Jose, Calif.), for example, to create a merchant account (e.g., including a merchant dashboard) and/or to update, view, or otherwise interact with a previously created merchant dashboard.

Consider, for example, a merchant that would like to create a new merchant account. In some embodiments, with reference to FIG. 3 and in an embodiment of block 202, upon launching the system provider application, the merchant may be presented with an “Account Creation” screen, as shown in the display 300a. In various examples, a merchant may be prompted to enter login information 302 (e.g., email address and password), as well as business contact information 304 (e.g., merchant's business name, phone number, and address), prior to selecting a continue button 306. Upon selecting the continue button 306, the system provider application may next present the merchant with a “Business Information” screen, as shown in the display 300a of FIG. 4. By way of example, the merchant may thereby be prompted to enter/select business profile information 402 (e.g., business type, business category, monthly sales estimate, website address, etc.), where such business profile information 402 may be identified as a merchant attribute, as discussed above. For purposes of illustration, in some embodiments, the ‘business type’ of the illustrated business profile information 402 may include a sole proprietorship, a partnership, a corporation, a non-profit entity, a government entity, business-to-business (B2B), business-to-consumer (B2C), consumer-to-business (C2B), consumer-to-consumer (C2C), or other business type as known in the art. In some cases, the ‘business category’ of business profile information 402 may include any of a plurality of goods (e.g., both tangible and intangible) and/or services. A merchant may further be prompted to enter a sales estimate as part of the business profile information 402, as well as a website address, if available. While some examples of information included in the business profile information 402 have been provided, those skilled in the art in possession of the present disclosure will recognize other types of information that may be included in the business profile information 402, while remaining within the scope of the present disclosure. After a merchant enters the requested business profile information 402 (e.g., merchant attributes) and selects a create account button 406, the request to create the merchant account, together with one or more merchant attributes, may be provided to the system provider, and the system provider may use the submitted login information 302, business contact information 304, and business profile information 402 to create the merchant account.

Thus, following block 202, the system provider device has received a request to create a merchant account and has determined one or more merchant attributes (e.g., based on the submitted business profile information 402). As discussed below, the system provider device may thus use the one or more determined merchant attributes to suggest one or more dashboard widgets to the merchant.

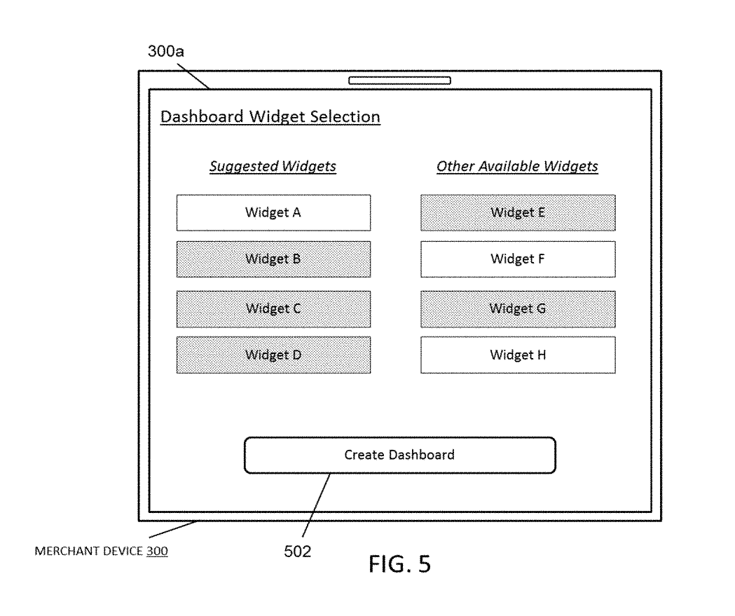

The method 200 proceeds to block 204 one or more dashboard widgets are suggested based on the determined one or more merchant attributes. With reference to the example of FIG. 5, an embodiment of block 204 is illustrated. In some embodiments, after selection of the create account button 406 (FIG. 4), the system provider application may next present the merchant with a “Dashboard Widget Selection” screen, as shown in the display 300a of FIG. 5. By way of example, based on the one or more determined merchant attributes (block 202), the system provider may provide a list of ‘Suggested Widgets’ (e.g., illustrated in FIG. 5 as a ‘Widget A’ button, a ‘Widget B’ button, a ‘Widget C’ button, and a ‘Widget D’ button). In some examples, the system provider may also provide a list of ‘Other Available Widgets’ (e.g., illustrated in FIG. 5 as a ‘Widget E’ button, a ‘Widget F’ button, a ‘Widget G’ button, and a ‘Widget H’ button). In some cases, the ‘Other Available Widgets’ may include widgets of general interest (e.g., weather widget, currency conversion widget, etc.) and/or other widgets that may or may not necessarily be associated with the merchant's particular business type or business attributes.

As discussed above, in some embodiments, the ‘Suggested Widgets’ may be based on the determined merchant attributes as well as on merchant usage data from other merchants 107 (FIG. 1). For the sake of illustration, consider an example where the system provider determines that substantially all merchants are using a payment service provider widget (e.g., a PayPal widget) in order to keep track of a merchant payment account balance. Thus, one of the ‘Suggested Widgets’ may include the payment service provider widget. In another example, the system provider may determine (e.g., based on the one or more merchant attributes) that a majority of the other merchants 107, which operate the same type of business as the merchant 102, utilize a specific widget. Thus, another of the ‘Suggested Widgets’ may include the specific widget used by the majority of other merchants 107 operating the same type of business as the merchant 102. To be sure, in various embodiments, the system provider may be configured to make such widget suggestions judiciously, for example, based on collected merchant attribute information, merchant usage data, or other empirical data. In other words, the widget suggestion methodology of the present disclosure is configured to be ‘smart’. For example, the system provider will not suggest a shipping widget to a merchant who only sells digital goods. While some examples of methods for providing the ‘Suggested Widgets’ have been provided, those skilled in the art in possession of the present disclosure will recognize other techniques of providing suggested widgets, while remaining within the scope of the present disclosure. Thus, following block 204, the system provider device has suggested one or more dashboard widgets based, at least in part, on the determined one or more merchant attributes.

The method 200 proceeds to block 206 where a selection of one or more dashboard widgets is received (e.g., by the system provider). Still referring to FIG. 5, an embodiment of block 206 is illustrated. For example, after the system provider has presented the ‘Suggested Widgets’ and ‘Other Available Widgets’ (e.g., via the display 300a), the merchant may select one or more of the widgets for the system provider to use for subsequent creation of the merchant dashboard. In the example of FIG. 5, the buttons representing ‘Widget B’, ‘Widget C’, ‘Widget D’, ‘Widget E’, and ‘Widget G’ are shown with a shaded pattern, indicating selection of those widgets. Once the merchant has made their selection of widgets, the merchant may then select a create dashboard button 502, sending the widget selections to the system provider. Thus, in an embodiment of block 206, the system provider receives the selection of widgets, which the system provider uses to generate a merchant dashboard, as discussed below.

The method 200 proceeds to block 208 where a merchant dashboard is created (e.g., by the system provider). In various examples, the created dashboard includes the widgets selected at block 206. With reference to the example of FIG. 6, an embodiment of block 208 is illustrated. In particular, after selection of the create dashboard button 502 (FIG. 5), the system provider application may then generate a merchant dashboard 602 (FIG. 6), as shown in the display 300a of the merchant device 300. It will be understood that the selection of widgets and their configuration, as shown in the example of FIG. 6, are merely exemplary and are presented for clarity of discussion. Those of skill in the art in possession of this disclosure will recognize that a variety of different widgets, in a variety of different configurations, may be equally used without departing from the scope of the present disclosure.

By way of example, the merchant dashboard 602 may be specifically customized for each given merchant (e.g., the merchant 102), as indicated by icon 605. In various embodiments, the merchant dashboard 602 may be a merchant's workflow starting point. That is, in some examples, when a merchant logs-in to the system, the merchant may initially be presented with the merchant dashboard 602, from which the merchant may then take further actions, as discussed below. Thus, the merchant dashboard 602 is configured to quickly provide a snapshot of the information/data that is most relevant to the merchant (e.g., merchant 102) for which the merchant dashboard 602 was created. In the exemplary merchant dashboard 602, illustrated therein is a plurality of widgets 604, 606, 608, 610, 612, 614, 616, 618, 620. In various embodiments, the plurality of widgets included in the merchant dashboard 602 includes those widgets previously selected at block 206 of the method 200. Moreover, in various embodiments, the plurality of widgets may convey data/information from a payment service provider (e.g., PayPal), as well as one or more third-party data sources (e.g., data sources 105). Thus, with consideration of the example of FIG. 6, the widget 604 may include a merchant account balance widget (e.g., with data provided by a payment service provider such as PayPal), the widget 606 may include a cash-in activity widget (e.g., with data provided by the payment service provider), the widget 608 may include a cash-out activity widget (e.g., with data provided by the payment service provider), the widget 610 may include a customer dispute widget (e.g., with data provided by the payment service provider), the widget 612 may include a sales volume widget (e.g., with data provided by a third-party source such as Salesforce.com of San Francisco, Calif/), the widget 614 may include a revenue trends widget (e.g., with data provided by Intuit/QuickBooks of Mountain View, Calif.), the widget 616 may include an expense trends widget (e.g., with data provided by Intuit/QuickBooks of Mountain View, Calif.), the widget 618 may include a cancellation rate widget for an email marketing service (e.g., with data provided by MailChimp of Atlanta, Ga.), and the widget 620 may include a click through rate widget for an email marketing service (e.g., with data provided by MailChimp of Atlanta, Ga.). In some embodiments, a third-party data source for email may include Gmail from Google of Mountain View, Calif., a third-party data source for shipping services may include Shippingeasy.com of Austin, Tex., and a third-party data source for online marketplace services may include Shopify.com of Ottowa, Ontario, Canada. The above examples of third-party service providers, which act as third-party data sources, are merely exemplary and are not meant to be limiting in any way. As discussed above, the third-party data sources may generally include, but are not limited to, email service providers, payment service providers, marketing service providers, accounting service providers, shipping service providers, social networking service providers, e-commerce service providers, and/or other third-party service providers as known in the art.

Regardless of the third-party data source, and in accordance with embodiments of the present disclosure, the third-party data sources may communicate their data (e.g., email, marketing data, inventory data, order data, shipping data, financial data such as revenues, expenses, and/or cash flow, customer reviews/disputes, or other business-relevant data) to the system provider, for appropriate formatting and subsequent display via the merchant dashboard 602. With reference again to the example of FIG. 6, each of the above-mentioned exemplary third-party data sources (e.g., Salesforce.com, Intuit/QuickBooks, MailChimp) may provide raw, unformatted data to the system provider device 108, and the system provider may thus format and visualize the raw data (e.g., into the respective widgets of FIG. 6) to provide the merchant dashboard 602. Thus, regardless of the third-party data source, the system provider is configured to provide a uniform presentation of the merchant dashboard 602. In various embodiments, data provided by the payment service provider is also formatted by the service provider for appropriate display via the widgets of the merchant dashboard 602. In various embodiments and in an embodiment of block 210 of the method 200, data and/or information updates, whether from the payment service provider or from a third-party data source, may be immediately pushed to the system provider for proper formatting and subsequent display/update of the appropriate widget(s) of the plurality of widgets of the merchant dashboard 602. Thus, the merchant dashboard system 100 may be configured to provide real-time updates of the data and/or information displayed via the plurality of widgets of the merchant dashboard 602. As used herein, “pushing” updates of data and/or information is used to describe providing updates (e.g., to the system provider) without a specific request from the system provider. Thus, for example, consider that an email marketing service (e.g., MailChimp) registers a change in a cancellation rate for a particular email marketing campaign. Rather than the system provider having to poll the third-party data source (e.g., MailChimp), the third-party email marketing service may immediately push the raw data including the updated cancellation rate to the system provider, and the system provider may thereby update the cancellation rate widget 618 in real-time. The above example provides an illustration of “active listeners”, in accordance with embodiments of the present disclosure, wherein the system provider is continually “listening” for data and/or information updates that may be pushed from any of a plurality of data sources, so as to provide a continuously updated merchant dashboard 602.

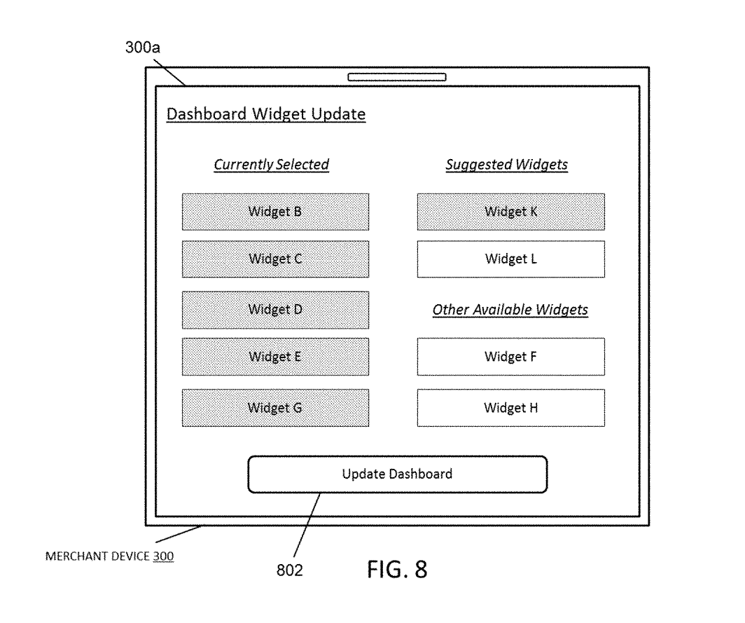

Referring again to the plurality of widgets shown in the merchant dashboard 602, each of the plurality of widgets 604, 606, 608, 610, 612, 614, 616, 618, 620 may be resized or removed, and new widgets may be added, for example via an add widget button 607. Other methods of adding widgets are discussed below with reference to FIG. 8. It is also noted that while the plurality of widgets of the merchant dashboard 602 are designed to provide a limited, but targeted custom data point, a user (e.g., the merchant) may interact with the merchant dashboard 602 in a variety of ways to drill deeper into a particular widget and/or to view expanded details related to one or more of the plurality of widgets. For example, in some cases, the merchant may click on one of the icons along a panel 609 of the merchant dashboard 602. By way of example, the merchant may select a money icon 624 to view expanded details, for example, regarding their payment service provider merchant account balance, funding sources, and/or other money management tasks. The merchant may select an activity icon 626 to view expanded details, for example, regarding transaction activity in their payment service provider merchant account. The merchant may select a reports icon 628 to view expanded details, for example, regarding payment service provider merchant account reports such as financial summary reports, projections, or other reports. The merchant may select a customer icon 630 to view expanded details, for example, regarding customer reviews, customer disputes, customer preferences, or other customer-related information. The merchant may select an invoicing icon 632 to view expanded details, for example, regarding invoices. The merchant may also select a dashboard icon 622 to return to the merchant dashboard 602. In addition, the merchant may select a widget store icon 634, for example, to purchase and/or download new widgets (e.g., provided by third-party service providers). Settings, including merchant dashboard 602 settings, may be configured by selecting a settings icon 636, and a user (e.g., the merchant) may log-out of their account by selecting a logout icon 638.

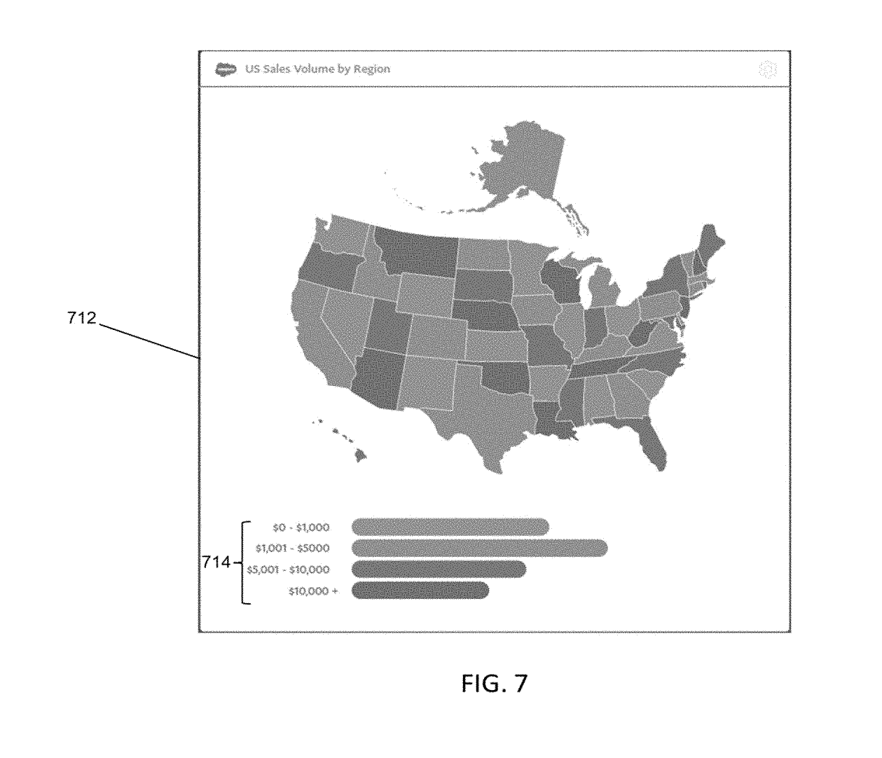

In some embodiments, in order to drill deeper into a particular widget, the merchant may click on (e.g., double-click on), or simply expand, a particular widget (e.g., by dragging the widget by a corner). By way of illustration, consider the sales volume widget 612. In the view of the merchant dashboard 602 of FIG. 6, the sales volume widget 612 provides a color-coded map of the United States, where different colors indicate different volumes of sales. However, the sales volume widget 612 does not provide a legend to match a color to a given volume of sales. In some examples, by placing a cursor over a particular state (e.g., California), a pop-up display may be provided showing a sales volume for that state (e.g., $4,435 for CA). In some examples, however, a merchant may want to quickly correlate the variety of colors provided in the color-coded map of the sales volume widget 612 to actual numbers and/or a range of numbers. Thus, in some embodiments, the merchant may click on (e.g., double-click on), or expand, the sales volume widget 612, thereby providing a detailed sales volume widget 712, as illustrated in FIG. 7. As shown, the detailed sales volume widget 712 provides a legend 714 (e.g., bar graph) which correlates the different colors of the color-coded map to sales volumes, in a variety of monetary ranges, allowing the merchant to quickly identify the performance of each state and/or region. In various embodiments, the merchant may close the detailed sales volume widget 712, or resize the detailed sales volume widget 712, to return to the merchant dashboard 602.

In another embodiment of the block 210, notifications may be pushed to the system provider, and the merchant may be alerted by a bell icon 611 in the merchant dashboard 602. In some embodiments, notifications delivered via the icon 611 may include notifications that may not be specific to a particular widget (e.g., specific to one of the plurality of widgets of the merchant dashboard 602), they may include notifications for time-sensitive information, or they may include other high-priority notifications.

The method 200 proceeds to block 212 where merchant data is collected. For example, in various embodiments, as the merchant (e.g., merchant 102) uses the merchant dashboard system 100, the system provider may collect merchant usage data from the merchant 102, as well as from the other merchants 107. As discussed above, the other merchants 107 may include merchants that have the same or similar business type as the merchant 102, merchants that are in the same or similar industry as the merchant 102, and/or merchants that have other attributes that are similar to the merchant 102. In some embodiments, the collected merchant usage data may include, for example, a list of widgets used by the merchant 102 as well as the other merchants 107, business attributes (e.g., as described above) for each of the merchant 102 and the other merchants 107, and/or other relevant merchant data and/or information.

The method 200 proceeds to block 214 where one or more additional dashboard widgets are suggested based on the collected merchant usage data. For example, in various embodiments, one or more additional and/or alternative dashboard widgets (e.g., to populate to merchant dashboard 602) may be suggested based on the merchant usage data collected at block 212. With reference to the example of FIG. 8, an embodiment of block 214 is illustrated. In some embodiments, after the merchant (e.g., merchant 102) uses the merchant dashboard system 100 for a period of time (e.g., minutes, hours, days, etc.), the system provider (e.g., by way of the system provider application) may present the merchant with a “Dashboard Widget Update” screen, as shown in the display 300a of FIG. 8. In some embodiments, the “Dashboard Widget Update” screen may be displayed by the system provider application without prior prompting, for example, after a prescribed time period. In other embodiments, the “Dashboard Widget Update” screen may be displayed by the system provider application upon prompting by a user (e.g., the merchant), for example, when attempting to add a new widget (e.g., by selection of the add widget button 607 (FIG. 6)). In yet other examples, the “Dashboard Widget Update” screen may be displayed by the system provider application upon detection of a trigger event, such as for example, detection by the system provider device of a newly available or updated widget (e.g., which may include a newly available or updated third-party widget or a newly available or updated payment service provider widget) that is determined to be relevant and of possible interest to the merchant (e.g., the merchant 102) interfacing with the merchant dashboard 602. By way of example, the newly available or updated widget may include an identifying attribute (e.g., a category name and/or number) that corresponds to a merchant attribute (e.g., of the merchant 102). To be sure, in some embodiments, the system provider application may present the “Dashboard Widget Update” screen immediately following the “Dashboard Widget Selection” screen (FIG. 5). For example, after a selection of widgets via the “Dashboard Widget Selection” screen, and after selection of the create dashboard button 502 (FIG. 5), the system provider may immediately thereafter present the “Dashboard Widget Update” screen to suggest one or more additional and/or alternative dashboard widgets based on previously collected merchant usage data or based on merchant usage data collected in real-time.

With reference to FIG. 8, in some embodiments, the “Dashboard Widget Update” screen may include a list of ‘Currently Selected’ widgets, for example selected at block 206, and illustrated in FIG. 8 as the ‘Widget B’ button including a shaded pattern to indicate selection of that button/widget, a shaded ‘Widget C’ button, a shaded ‘Widget D’ button, a shaded ‘Widget E’ button, and a shaded ‘Widget G’ button. By way of example, based on the collected merchant usage data (e.g., the merchant 102 and/or the other merchants 107), the system provider may provide a list of ‘Suggested Widgets’ (e.g., illustrated in FIG. 8 as a ‘Widget K’ button and a ‘Widget L’ button). In some examples, the system provider may also provide a list of ‘Other Available Widgets’ (e.g., illustrated in FIG. 8 as a ‘Widget F’ button and a ‘Widget H’ button.

As discussed above, in some embodiments, the ‘Suggested Widgets’ may be based on the collected merchant usage data (e.g., from the merchant 102 and/or the other merchants 107), where the collected merchant usage data may include, for example, a list of widgets used by the merchant 102 as well as the other merchants 107, business attributes (e.g., as described above) for each of the merchant 102 and the other merchants 107, and/or other relevant merchant data and/or information. For the sake of illustration, consider an example where the system provider determines, by the collected merchant usage data, that the merchant using the merchant dashboard 602 (e.g., the merchant 102) is using a first set of widgets—‘Widget X’, ‘Widget Y’, and ‘Widget Z’. Then, consider that the system provider collects merchant usage data for other merchants (e.g., the other merchants 107) which have one or more shared attributes with the merchant 102 (e.g., they are in the same or similar industry). By way of example, based on the collected merchant usage data, the system provider may then determine that around 75% (or other predetermined threshold percentage) of the other merchants 107, that have the one or more shared attributes with the merchant 102, that use the first set of widgets (X, Y, and Z) also use a ‘Widget R’. Thus, the system provider determines that the ‘Widget R’ may likewise be of use to the merchant 102, and thus one of the ‘Suggested Widgets’ may include the ‘Widget R’. Thus, following block 214, the system provider device has suggested one or more dashboard widgets based, at least in part, on the collected merchant usage data.

The method 200 proceeds to block 216 where a selection of one or more dashboard widgets is received (e.g., by the system provider). Still referring to FIG. 8, an embodiment of block 216 is illustrated. For example, after the system provider has presented the ‘Currently Selected Widgets’, ‘Suggested Widgets’ and ‘Other Available Widgets’ (e.g., via the display 300a), the merchant may select one or more of the ‘Suggested Widgets’ or ‘Other Available Widgets’, and/or the merchant may un-select one or more of the ‘Currently Selected’ widgets. The system provider may then use the merchant selections/un-selections for subsequent update of the existing (e.g., previously created) merchant dashboard. In the example of FIG. 8, the buttons representing ‘Widget B’, ‘Widget C’, ‘Widget D’, ‘Widget E’, and ‘Widget G’ are shown with a shaded pattern, since those widgets are part of the ‘Currently Selected’ widgets. In addition, the button representing ‘Widget K’ is also shown with a shaded pattern, indicating selection of one of the ‘Suggested Widgets’, selection of which is then used to update the existing merchant dashboard (e.g., the merchant dashboard 602). Once the merchant has made their updated selection of widgets, the merchant may then select an update dashboard button 802, sending the widget selections to the system provider. Thus, in an embodiment of block 216, the system provider receives the updated selection of widgets, which the system provider uses to update the existing merchant dashboard, as discussed below.

The method 200 proceeds to block 218 where a merchant dashboard is updated (e.g., by the system provider). For example, in some embodiments, the merchant dashboard 602 may be updated (e.g., widgets may be added and/or removed) at block 218, based on selections made at block 216. In at least one example, based on the selection of ‘Widget K’ (FIG. 8) at block 216, the merchant dashboard (e.g., the merchant dashboard 602) may be updated to include ‘Widget K’, for example, upon processing of the sections (e.g., by the system provider) after the merchant selects the update dashboard button 802 (FIG. 8).

It will be understood that the examples given above, for example with reference to the method 200, are merely exemplary and are not meant be limiting in any way. Moreover, those of skill in the art in possession of this disclosure will recognize that various additional embodiments may be implemented in accordance with the methods described herein, while remaining within the scope of the present disclosure.

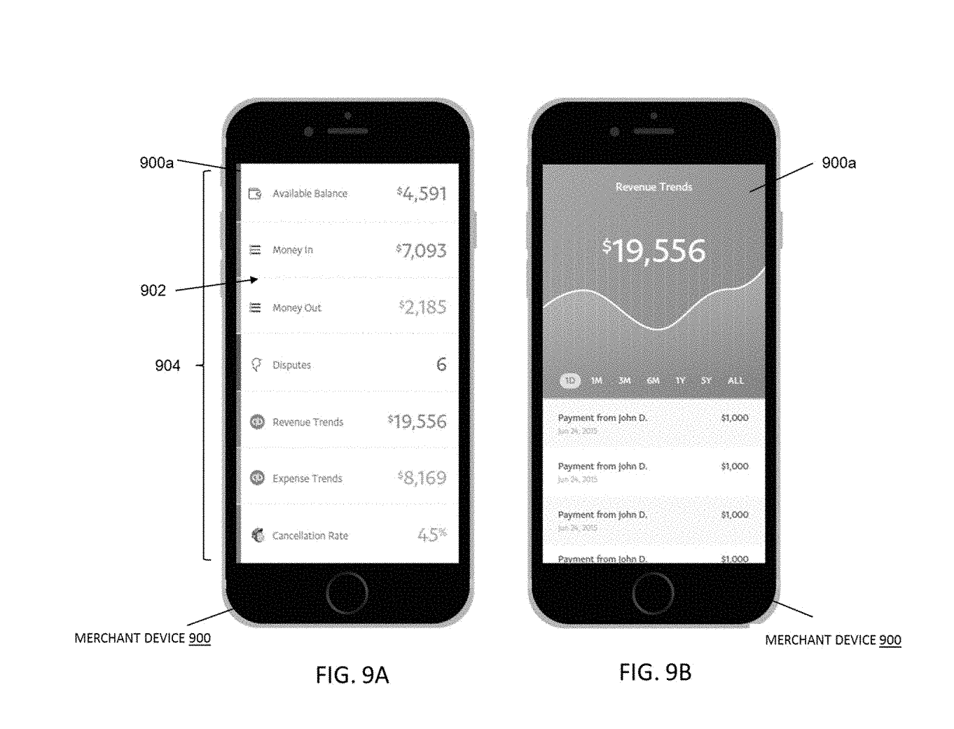

Referring now to FIGS. 9A and 9B, illustrated therein is an example of a merchant device 900, which in some embodiments may include the merchant device 300, discussed above. In various examples, the merchant device 900 may include a display 900a which may include a touchscreen user interface. In the example of FIGS. 9A/9B, the merchant device 900 includes a mobile phone, but as discussed above, other embodiments of the merchant device may include a laptop computer, a desktop computer, a tablet, and/or any of a variety of other type of computing device as known in the art. In various embodiments, a merchant associated with the merchant device 900 may launch a system provider application and/or a payment service provider application (e.g., on the merchant device 900), for example, to create a merchant account (e.g., including a merchant dashboard) and/or to update, view, or otherwise interact with a previously created merchant dashboard. In various examples, a merchant may further use the merchant device 900 to implement one or more aspects of the method 200, discussed above. In various embodiments, a merchant dashboard 902 may be displayed via the display 900a of the merchant device 900. By way of example, the merchant dashboard may include a plurality of widgets 904 that are configured to quickly provide a snapshot of the information/data that is most relevant to the merchant using the merchant device 900. In some examples, the merchant may also drill deeper to get more information related to a particular widget. For example, FIG. 9B illustrates an expanded, detailed view of the ‘Revenue Trends’ widget shown in FIG. 9A.

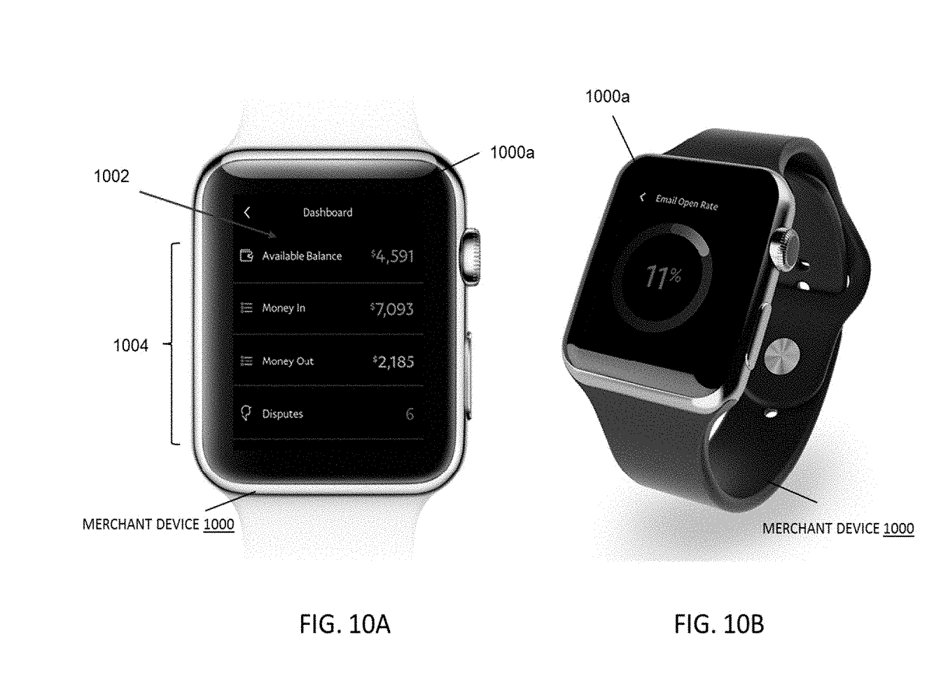

Referring to FIGS. 10A and 10B, illustrated therein is an example of a merchant device 1000, which in some embodiments may include the merchant device 300, discussed above. In various examples, the merchant device 1000 may include a display 1000a which may include a touchscreen user interface. In the example of FIGS. 10A/10B, the merchant device 1000 includes a smart watch, but as discussed above, other embodiments of the merchant device may equally be used to implement the systems and methods disclosed herein. In various embodiments, a merchant associated with the merchant device 1000 may launch a system provider application and/or a payment service provider application (e.g., on the merchant device 1000), for example, to create a merchant account (e.g., including a merchant dashboard) and/or to update, view, or otherwise interact with a previously created merchant dashboard. In various examples, a merchant may further use the merchant device 1000 to implement one or more aspects of the method 200, discussed above. In various embodiments, a merchant dashboard 1002 may be displayed via the display 1000a of the merchant device 1000. By way of example, the merchant dashboard may include a plurality of widgets 1004 that are configured to quickly provide a snapshot of the information/data that is most relevant to the merchant using the merchant device 1000. In some examples, the merchant may also drill deeper to get more information related to a particular widget. For example, FIG. 10B illustrates an expanded, detailed view of an ‘Email Open Rate’ widget, an abbreviated version of which may be provided via the merchant dashboard 1002 of FIG. 10A.

As discussed with reference to FIGS. 3, 9A/9B, and 10A/10B, the merchant device may include any of a variety of types of computing devices as known in the art such as a mobile phone, a laptop computer, a desktop computer, a tablet, or other suitable device. Thus, in various embodiments, the same and/or similar data may be presented to the merchant on a variety of different devices. As such, in some examples, there may be different levels on merchant-merchant device interaction based on the particular type of merchant device that is used. For example, the smart watch merchant device 1000 may not provide the same level of data and/or interaction as for example a desktop or laptop computer. Nevertheless, employing embodiments of the present disclosure on such an array of different devices allows important, timely data and/or other information to be readily and conveniently consumed by a merchant in whatever form is best suited to the merchant's particular desire or application. In some cases, a merchant may want a quick view (e.g., a smart watch notification to return to the office because a package has arrived), and other times the merchant may want to dig deeper into the merchant dashboard (e.g., a desktop dashboard view providing a more in depth view of financial transactions), but in any case the merchant does not want to be disconnected from their data, and the embodiments presented herein ensure that merchants stay connected to data and/or information that impacts their business.

In another aspect of the present disclosure, a color coding scheme may also be used to quickly and effectively communicate various types of information. For example, regardless of the data source (e.g., payment service provider or third-party source), colors may be used to convey a performance level for a given metric which the merchant may be monitoring via a merchant dashboard widget (e.g., such as any of the plurality of widgets of the merchant dashboard 602, the plurality of widgets 904, or the plurality of widgets 1004). By way of example, in some cases, portions of a widget (e.g., numbers) or other graphics (e.g., such as the map and bar graph shown in the expanded, detailed widget 712) may be shown in a variety of different colors to convey the performance level for the given metric. In some embodiments, a blue color may indicate an average performance, a green color may indicate an above average performance, and a red color may indicate a poor performance. In some cases, various shades of colors (e.g., various shades of blue, green, or red) may be used to indicate relative performance within a given performance level. For example, a dark red color may indicate a poorer performance level than a light red color, a dark green color may indicate a better performance than a light green color, and a dark blue color may indicate a better performance than a light blue color.

In some cases, a merchant's performance benchmark may be set by the merchant's past performance as well as by the performance of other merchants who are in the same and/or similar category as the merchant. Such a performance benchmark may thus be used to determine relative performance levels and colors to implement in the color coding scheme. By implementing these performance benchmarks and color coding scheme, a merchant may quickly glance at the merchant dashboard and promptly get a sense of whether they are doing well, average, or poorly versus other, potentially competitive, merchants in the same or similar industry. Thus, the color coding scheme may be considered as providing data that may not be presented as part of a widget itself, but rather the color coding scheme may be considered as a data/information enhancement, further assisting the merchant in the daily tasks associated with running their business.

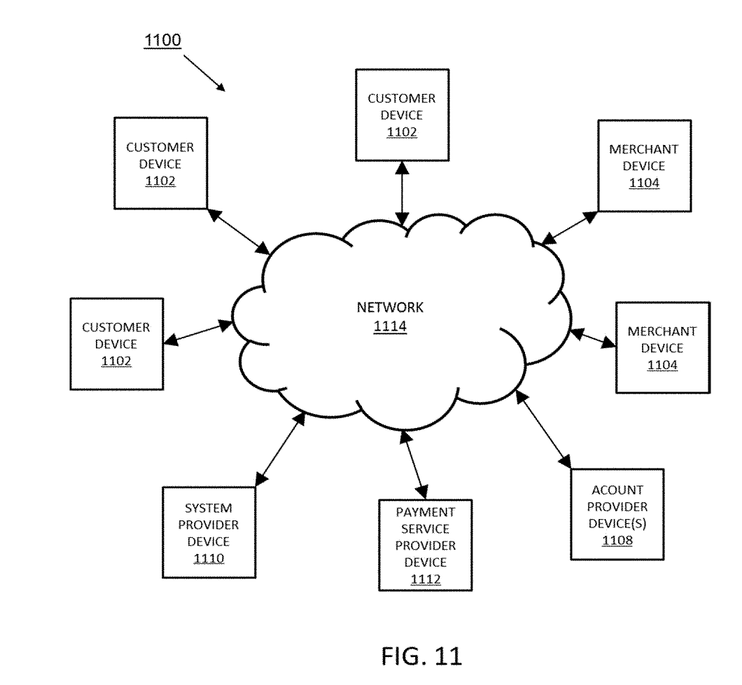

Thus, systems and methods have been described that provide for a merchant dashboard system that provides merchants with a customizable dashboard (e.g., providing data visualization) that may be configured on a merchant-by-merchant basis (e.g., by selection of appropriate dashboard widgets) to report information from any of a plurality of data sources to a merchant. In various examples, and in accordance with the various embodiments described herein, the system provider device may receive a request to create a merchant account and determine one or more merchant attributes, which the system provider device may thereby use to suggest one or more dashboard widgets. The system provider device may then receive a selection of one or more dashboard widgets (e.g., from a merchant), and thereby create a customized merchant dashboard based on the received selections. Thereafter, merchant usage data may be collected and additional dashboard widgets may be suggested, thereby providing a mechanism to update the merchant dashboard with timely and relevant widgets that may be of use to the merchant. Thus, the embodiments described herein provide merchants with a customizable, intelligent merchant dashboard system that actively assists the merchant in the completion of a variety of merchant-related tasks. It is additionally noted that the embodiments described herein describe technological solutions to problems associated with e-commerce business practices, which include business practices that did not exist prior to the advent of computer networks and the Internet. Various examples of technological devices and systems that may be used to implement embodiments of the present disclosure are discussed in more detail below with reference to FIGS. 11-14.

Referring first to FIG. 11, an embodiment of a network-based system 1100 for implementing one or more processes described herein is illustrated. As shown, the network-based system 1100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 11 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1100 illustrated in FIG. 11 includes a plurality of customer devices 1102, a plurality of merchant devices 1104, a payment service provider device 1112, account provider device(s) 1108, and/or a system provider device 1110 in communication over one or more networks 1114. The customer devices 1102 may be the customer devices discussed above and may be operated by the customers discussed above. The merchant devices 1104 may be the merchant devices discussed above and may be operated by the merchants discussed above. The payment service provider device 1112 may be the payment service provider devices discussed above and may be operated by a payment service provider such as, for example, PayPal Inc. of San Jose, Calif. The system provider devices 1110 may be the system provider devices discussed above and may be operated by the system providers discussed above. The account provider devices 1108 may be operated by credit card account providers, bank account providers, savings account providers, and a variety of other account providers known in the art.

The customer devices 1102, merchant devices 1104, payment service provider device 1112, account provider devices 1108, and/or system provider device 1110 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1114.

The network 1114 may be implemented as a single network or a combination of multiple networks. For example, in various embodiments, the network 1114 may include the Internet and/or one or more intranets, landline networks, wireless networks, and/or other appropriate types of networks.

The customer devices 1102 and/or merchant devices 1104 may be implemented using any appropriate combination of hardware and/or software configured for wired and/or wireless communication over network 1114. For example, in one embodiment, the customer devices 1102 and/or merchant devices 1104 may be implemented as a personal computer of a user in communication with the Internet. In other embodiments, the customer devices 1102 and/or merchant devices 1104 may be a smart phone, wearable computing device, laptop computer, and/or other types of computing devices.

The customer devices 1102 and/or merchant devices 1104 may include one or more browser applications which may be used, for example, to provide a convenient interface to permit the customer to browse information available over the network 1114. For example, in one embodiment, the browser application may be implemented as a web browser configured to view information available over the Internet.

The customer devices 1102 and/or merchant devices 1104 may also include one or more toolbar applications which may be used, for example, to provide user-side processing for performing desired tasks in response to operations selected by the customer and/or the merchant. In one embodiment, the toolbar application may display a user interface in connection with the browser application.

The customer devices 1102 and/or merchant devices 1104 may further include other applications as may be desired in particular embodiments to provide desired features to the customer devices 1102 and/or merchant devices 1104. In particular, the other applications may include a payment application for payments assisted by a payment service provider through the payment service provider device 1112. The other applications may also include security applications for implementing user-side security features, programmatic user applications for interfacing with appropriate application programming interfaces (APIs) over the network 1114, or other types of applications. Email and/or text applications may also be included, which allow customer payer to send and receive emails and/or text messages through the network 1114. The customer devices 1102 and/or merchant devices 1104 may include one or more user and/or device identifiers which may be implemented, for example, as operating system registry entries, cookies associated with the browser application, identifiers associated with hardware of the customer devices 1102 and/or merchant devices 1104, or other appropriate identifiers, such as a phone number. In one embodiment, the user identifier may be used by the payment service provider device 1112 and/or account provider device 1108 to associate the user with a particular account as further described herein.

The merchant devices 1104 may be maintained, for example, by a conventional or on-line merchant, conventional or digital goods seller, individual seller, and/or application developer offering various products and/or services in exchange for payment to be received conventionally or over the network 1114. In this regard, the merchant device 1104 may include a database identifying available products and/or services (e.g., collectively referred to as items) which may be made available for viewing and purchase by the customer.

The merchant devices 1104 also include a checkout application which may be configured to facilitate the purchase by the payer of items. The checkout application may be configured to accept payment information from the user through the customer devices 1102, the account provider through the account provider device 1108, and/or from the payment service provider through the payment service provider device 1112 over the network 1114. The merchant devices 1104 may also include a system provider application, as described above, to implement one or more aspects of the method 200 and/or other aspects of the various embodiments described herein.

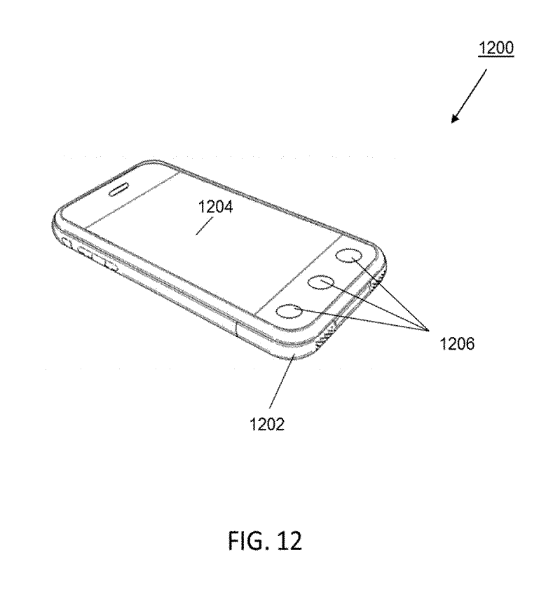

Referring now to FIG. 12, an embodiment of a merchant device 1200 is illustrated. The merchant device 1200 may be the merchant device 300, 900, 1000, or 1104 discussed above. The merchant device 1200 includes a chassis 1202 having a display 1204 and an input device including the display 1204 and a plurality of input buttons 1206. One of skill in the art will recognize that the merchant device 1200 is a portable or mobile phone including a touch screen input device and a plurality of input buttons that allow the functionality discussed above with reference to the methods above. However, a variety of other portable/mobile merchant devices and/or desktop merchant devices may be used in the methods discussed above without departing from the scope of the present disclosure.

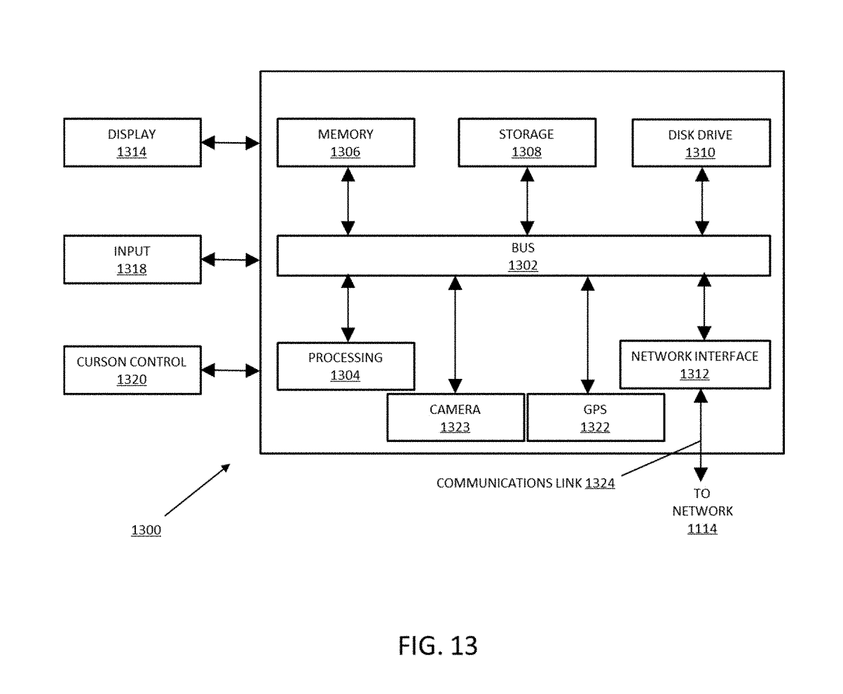

Referring now to FIG. 13, an embodiment of a computer system 1300 suitable for implementing, for example, the customer device 1102, the merchant device 300, 900, 1000, or 1104, the payment service provider device 1112, the account provider device(s) 1108, and/or the system provider devices 108 or 1110, is illustrated. It should be appreciated that other devices utilized by customers, merchants, beacon devices, merchant beacon communication devices, payment service providers, account provider device(s), and/or system providers in the system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), a location determination component 1322 (e.g., a Global Positioning System (GPS) device as illustrated, a cell tower triangulation device, and/or a variety of other location determination devices known in the art), and/or a camera component 1323. In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the customer devices 1102, the merchant device 300, 900, 1000, or 1104, the payment service provider device 1112, the account provider device(s) 1108, and/or the system provider devices 108 or 1110. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1114 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

Referring now to FIG. 14, an embodiment of a system provider device 1400 is illustrated. In an embodiment, the device 1400 may be the system provider devices discussed above. The device 1400 includes a communication engine 1402 that is coupled to the network 1114 and to widget engine 1404 that is coupled to a merchant information database 1406 and a widget database 1408. The communication engine 1402 may be software or instructions stored on a computer-readable medium that allows the device 1400 to send and receive information over the network 1114. The widget engine 1404 may be software or instructions stored on a computer-readable medium that, when executed by a processor, is configured receive a request to create a merchant account and determine one or more merchant attributes, suggest one or more dashboard widgets, receive a selection of one or more dashboard widgets, create a customized merchant dashboard, collect merchant usage data, suggest additional dashboard widgets, and update the merchant dashboard, as well as provide any of the other functionality that is discussed above. While the databases 1406 and 1408 have been illustrated as located in the device 1400, one of skill in the art will recognize that they may be connected to the widget engine 1404 through the network 1114 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A merchant dashboard system, comprising:
a non-transitory memory storing widget information; and
one or more hardware processors coupled to the non-transitory memory and configured to read instructions from the non-transitory memory to cause the system to perform operations comprising:
receiving a request to setup a merchant account;
responsive to the request, determining at least one merchant attribute;
based on the at least one determined merchant attribute, suggesting at least one dashboard widget for display within a merchant dashboard; and
displaying, by way of a merchant device, the merchant dashboard including the at least one dashboard widget.

2. The system of claim 1, wherein the one or more hardware processors are further configured to read instructions from the at least one non-transitory memory to cause the system to perform operations comprising:
identifying another merchant that shares the at least one merchant attribute; and
suggesting another dashboard widget, used by the another merchant, for display within the merchant dashboard.

3. The system of claim 1, wherein the one or more hardware processors are further configured to read instructions from the at least one non-transitory memory to cause the system to perform operations comprising:
prior to the displaying, receiving a widget selection from a merchant.

4. The system of claim 1, wherein the one or more hardware processors are further configured to read instructions from the at least one non-transitory memory to cause the system to perform operations comprising:
receiving data from at least one third-party source; and
formatting the received data and displaying the received data by the at least one dashboard widget.

5. The system of claim 1, wherein the one or more hardware processors are further configured to read instructions from the at least one non-transitory memory to cause the system to perform operations comprising:
receiving data from at least one third-party source, wherein the received data is not associated with the at least one dashboard widget; and
creating a notification, displayed within the merchant dashboard, to alert the merchant.

6. The system of claim 1, wherein the one or more hardware processors are further configured to read instructions from the at least one non-transitory memory to cause the system to perform operations comprising:
collecting merchant usage data for a plurality of merchants, wherein the plurality of merchants share at least one merchant attribute; and
suggesting another dashboard widget, based on the collected merchant usage data, for display within the merchant dashboard.

7. The system of claim 6, wherein the collected merchant usage data includes a list of widgets used by each of the plurality of merchants.

8. The system of claim 6, wherein the one or more hardware processors are further configured to read instructions from the at least one non-transitory memory to cause the system to perform operations comprising:
updating the merchant dashboard to include the another dashboard widget for display within the merchant dashboard.

9. The system of claim 1, wherein the one or more hardware processors are further configured to read instructions from the at least one non-transitory memory to cause the system to perform operations comprising:
determining a performance level for a given metric monitored by a merchant;
based on the determined performance level, assigning a corresponding color to the at least one widget; and
displaying, by way of a merchant device, the merchant dashboard including the at least one dashboard widget having the assigned color corresponding to the determined performance level.

10. The system of claim 9, wherein the performance level is determined based on a combination of the merchant's past performance and the past performance of another merchant that shares the at least one merchant attribute with the merchant.

11. A method for providing a merchant dashboard, comprising:
receiving, by a system provider device through a network, a request to setup a merchant account;
responsive to the request, determining, by the system provider device, at least one merchant attribute;
based on the at least one determined merchant attribute, suggesting, by the system provider device, at least one dashboard widget for display within a merchant dashboard; and
displaying, by the system provider device and through a merchant device, the merchant dashboard including the at least one dashboard widget.

12. The method of claim 11, further comprising:
identifying, by the system provider device, another merchant that shares the at least one merchant attribute; and
suggesting, by the system provider device, another dashboard widget, used by the another merchant, for display within the merchant dashboard.

13. The method of claim 11, further comprising:
receiving, by the system provider device, data from at least one third-party source;
formatting, by the system provider device, the received data; and
displaying, by the system provider device, the received data by the at least one dashboard widget.

14. The method of claim 11, further comprising:
receiving, by the system provider device, data from at least one third-party source, wherein the received data is not associated with the at least one dashboard widget; and
creating, by the system provider device, a notification that is displayed within the merchant dashboard to alert the merchant.

15. The method of claim 11, further comprising:
collecting, by the system provider device, merchant usage data for a plurality of merchants, wherein the plurality of merchants share at least one merchant attribute; and
suggesting, by the system provider device, another dashboard widget, based on the collected merchant usage data, for display within the merchant dashboard.

16. The method of claim 11, further comprising:
determining, by the system provider device, a performance level for a given metric monitored by a merchant;
based on the determined performance level, assigning, by the system provider device, a corresponding color to the at least one widget; and
displaying, by the system provider device and through a merchant device, the merchant dashboard including the at least one dashboard widget having the assigned color corresponding to the determined performance level.

17. A non-transitory machine-readable medium having stored thereon machine-readable instructions executable to cause a machine to perform operations comprising:
receiving a request to setup a merchant account;
responsive to the request, determining at least one merchant attribute;
based on the at least one determined merchant attribute, suggesting at least one dashboard widget for display within a merchant dashboard; and
displaying, by way of a merchant device, the merchant dashboard including the at least one dashboard widget.

18. The non-transitory machine-readable medium of claim 17, wherein the method further comprises:
identifying another merchant that shares the at least one merchant attribute; and
suggesting another dashboard widget, used by the another merchant, for display within the merchant dashboard.

19. The non-transitory machine-readable medium of claim 17, wherein the method further comprises:
receiving data from at least one third-party source; and
formatting the received data and displaying the received data by the at least one dashboard widget.

20. The non-transitory machine-readable medium of claim 17, wherein the method further comprises:
collecting merchant usage data for a plurality of merchants, wherein the plurality of merchants share at least one merchant attribute; and
suggesting another dashboard widget, based on the collected merchant usage data, for display within the merchant dashboard.
